(19) United States
(12) Patent Application Publication
(10) Pub. No.: US 2025/0390300 A1
(43) Pub. Date: Dec. 25, 2025

(54) SYSTEM AND METHOD FOR SYNCHRONIZING DISTRIBUTED MICROSERVICES AND MONOLITHIC SYSTEMS

(71) Applicant: INTUIT INC., Mountain View, CA (US)

(72) Inventors: Saket MALVIYA, Mountain View, CA (US); Vipin GUPTA, Mountain View, CA (US); Patteaswaran KARIVARADASAMY, Mountain View, CA (US)

(73) Assignee: INTUIT INC., Mountain View, CA (US)

(21) Appl. No.: 18/749,604

(22) Filed: Jun. 20, 2024

(51) Int. Cl. G06F 8/76; H04L 67/02; H04L 67/10

(52) U.S. Cl. CPC G06F 8/76; H04L 67/02; H04L 67/10

(57) ABSTRACT

Systems and methods for synchronizing distributed microservices and monolithic systems.

### BACKGROUND OF THE DISCLOSURE

In the realm of software architecture, monolithic applications and microservices represent two approaches to building and deploying software systems. Monolithic architectures generally utilize a single-tiered software application in which the user interface and data access code are combined into a single program from a single platform. This approach has been the traditional method for building enterprise applications, offering simplicity in terms of deployment and development.

On the other hand, microservice architectures are generally comprised of independently deployable, modular services. Each service can run a specific process and communicate through a well-defined, lightweight mechanism, such as a REST (Representational State Transfer) API (Application Programming Interface). Microservices offer several advantages over monolithic architectures, including improved scalability, flexibility, and resilience.

In addition, transitioning from monolithic systems to a microservice-based architecture has become common to improve system scalability and flexibility. However, this transition often involves challenges related to data consistency and integrity, especially when data is distributed across different services. The distributed nature of the data and requirements to maintain a consistent and unified view of the data across the monolith and the microservices compounds this complexity and can potentially incur significant overhead costs to manage it effectively, which is undesirable.

### BRIEF DESCRIPTION OF THE FIGURES

FIG. 1 is a block diagram of an example system for synchronizing distributed microservices and monolithic systems according to example embodiments of the present disclosure.

FIG. 2 is a flowchart of an example process for synchronizing distributed microservices and monolithic systems according to example embodiments of the present disclosure.

FIG. 3 is a flowchart of an example data validation process according to example embodiments of the present disclosure.

FIG. 4 is a server device that can be used within the system of FIG. 1 according to an embodiment of the present disclosure.

FIG. 5 is an example computing device that can be used within the system of FIG. 1 according to an embodiment of the present disclosure.

The drawings are not necessarily to scale, or inclusive of all elements of a system, emphasis instead generally being placed upon illustrating the concepts, structures, and techniques sought to be protected herein.

### DESCRIPTION

The following detailed description is merely exemplary in nature and is not intended to limit the claimed invention or the applications of its use.

Embodiments of the present disclosure relate to a system and method for synchronizing distributed microservices and monolithic systems. In particular, the disclosed system and method can utilize an event-driven mechanism to maximize data consistency and integrity across a system comprising a monolithic application and various decomposed microservices. For example, a system can include a monolithic application (i.e., a large-scale, legacy application with multiple integrated capabilities that share a common database) and a plurality of microservices (i.e., independent, scalable, and modular services that can each represent a capability decomposed from the monolithic application). The microservices and the capabilities contained within the monolithic application can access and rely on the same data in the monolithic database, and the disclosed system and method can ensure that the data across the entities is consistently synchronized and maintains integrity. Moreover, the disclosed system can include various mechanisms to handle transaction scenarios, ensuring data changes in one part of the system (i.e., the monolith or one of the microservices) are accurately and efficiently propagated to the other parts of the system. The system can also account for failure scenarios and provide a clear pathway for compensating actions to maintain system-wide consistency.

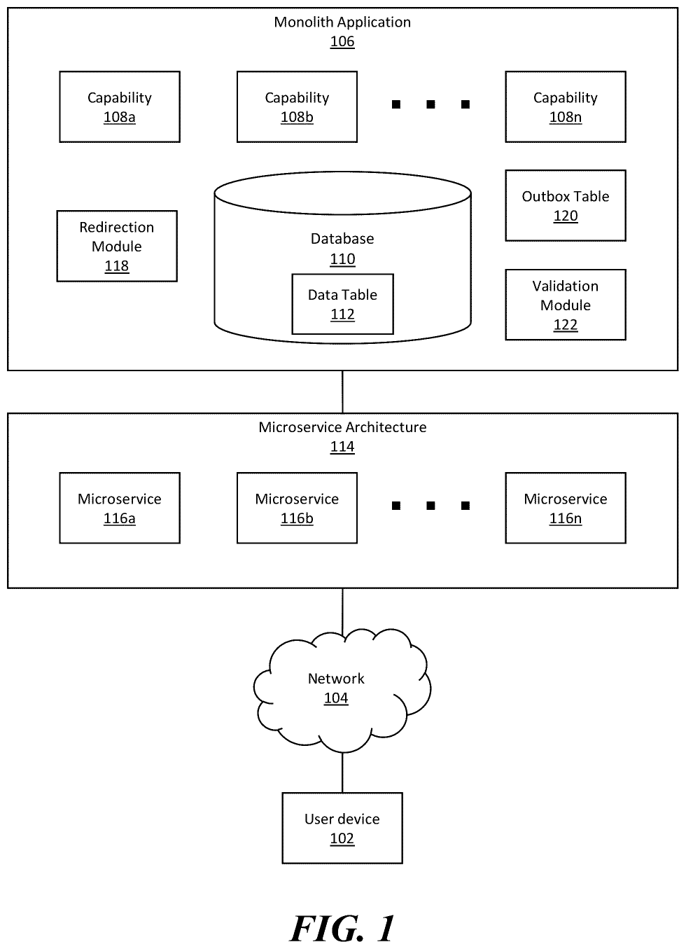

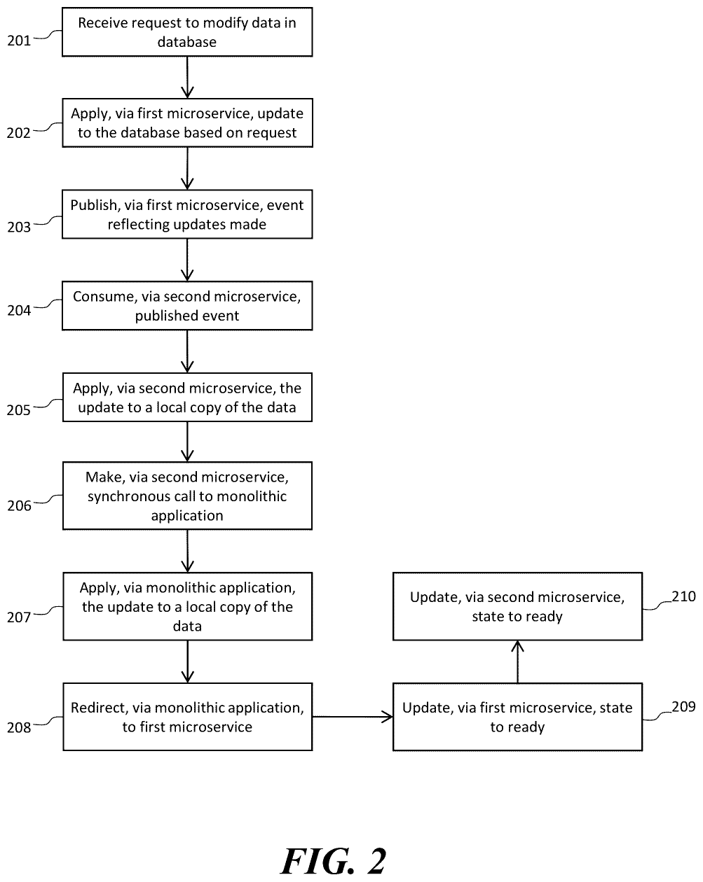

FIG. 1 is a block diagram of an example system 100 for synchronizing distributed microservices and monolithic systems according to example embodiments of the present disclosure. The system 100 can include one or more user devices 102 (generally referred to herein as a “user device 102” or collectively referred to herein as “user devices 102”) that can access, via network 104, a monolithic application 106, its various capabilities 108a-n, and various microservices 116a-n residing in a microservice architecture 114. In some embodiments, the monolithic application 106 can be a large-scale monolithic application, such as an accounting software tool. The monolithic application 106 can handle and maintain a database 110 that includes an exemplary data table 112, which can be accessible by the various capabilities 108a-n and the microservices 116a-n. In one example, where the data table 112 stores products and service information for an entity, a first microservice 116a can be a product information management tool and a second microservice 116b can be an inventory management tool. In this example, both microservices 116a and 116b can access and populate the data table 112 for sales transactions so that the entity has updated and current knowledge. Moreover, the monolithic application 106 can also include a redirection module 118 that is configured to redirect API requests to certain microservices for handling (additional details are discussed in relation to FIG. 2). The monolithic application 106 can also include an outbox table 120 that is accessible by each of the capabilities 108a-n and the microservices 116a-n. In addition, the monolithic application 106 can include a validation module 122 that is configured to implement checks to ensure data consistency across the various system components.

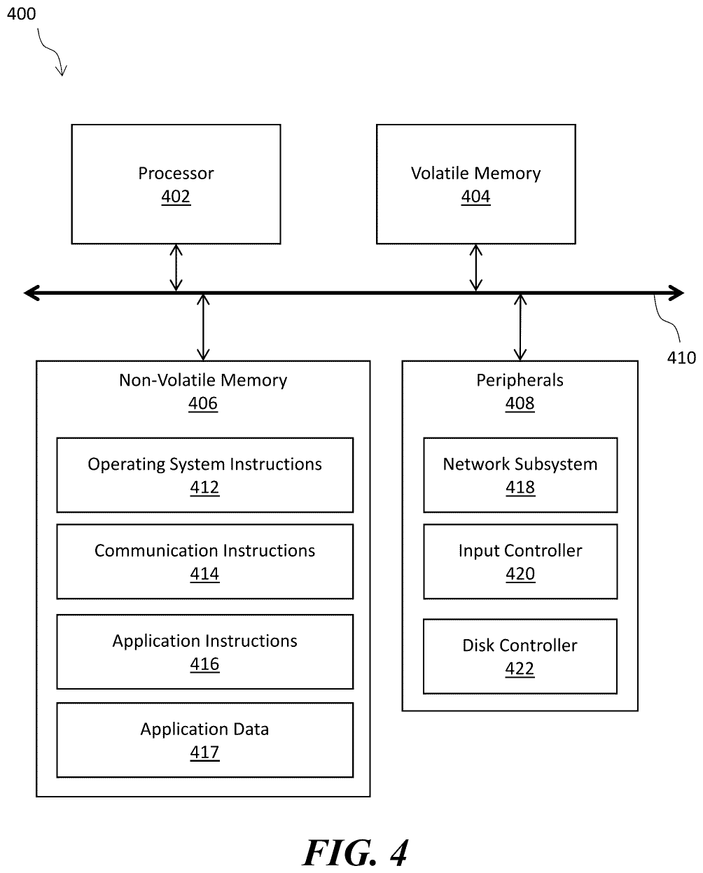

A user device 102 can include one or more computing devices capable of receiving user input, transmitting and/or receiving data via the network 104, and or communicating with the monolithic application 106. In some embodiments, a user device 102 can be a conventional computer system, such as a desktop or laptop computer. Alternatively, a user device 102 can be a device having computer functionality, such as a personal digital assistant (PDA), a mobile telephone, a smartphone, tablet, or other suitable device. In some embodiments, a user device 102 can be the same as or similar to the computing device 400 described below with respect to FIG. 4. In some embodiments, the system 100 can include any number of user devices 102.

The network 104 can include one or more wide areas networks (WANs), metropolitan area networks (MANs), local area networks (LANs), personal area networks (PANs), or any combination of these networks. The network 104 can include a combination of one or more types of networks, such as Internet, intranet, Ethernet, twisted-pair, coaxial cable, fiber optic, cellular, satellite, IEEE 801.11, terrestrial, and/or other types of wired or wireless networks. The network 104 can also use standard communication technologies and/or protocols.

In some embodiments, one microservice (e.g., microservice 116a) can be defined as the system of record (SOR) of the system 100 and another microservice (e.g., microservice 116b) can be defined as the system of reference (SoREF). In some embodiments, an SOR can act as an authoritative source for data related to the data table 112. For example, the SOR can be configured to perform creation, updating, and deletion operations of data within the data table 112. Moreover, the SOR can include the business rules and logic as defined by the relevant entity. The SOR can help ensure that the other system components (i.e., the monolithic application 106, its capabilities 108a-n, and the other microservices 116b-n) refer to it for the most current and accurate data. In other words, the SOR (i.e., microservice 116a) is configured to propagate data changes to the data table 112.

In some embodiments, an SoREF (e.g., microservice 116b) can hold a reference copy of the data table 112 that is managed by the SOR. In other words, in this example, microservice 116b can store a local reference copy of the data table 112, as can the monolithic application 106. In some embodiments, the SoREF can be optimized for read operations and can treat data within the data table 112 as read-only, instead of relying on the microservice the first 116a for processing data changes.

In some embodiments, the monolithic application 106 and the microservices 116a-b can utilize a distributed cache sourced by the first microservice 116a. For example, if a read request for an entity within the data table 112 is received by the monolithic application 106, the monolithic application 106 can use the same distributed cache to read the information. In some embodiments, the distributed cache can be maintained as a write through cache so that updates to existing data can invalidate the cache and update it with the latest information. In some embodiments, the SoREF reads data from the cache while the SOR performs the updates.

Moreover, the system 100 can utilize various “states” (e.g., “pending,” “ready”, etc.) to indicate when certain updates, additions, or other modifications to the data table 112 have been consistently made across the system. Additional details on the various states utilized herein are described in relation to FIG. 2.

FIG. 2 is a flowchart of an example process 200 for synchronizing distributed microservices and monolithic systems according to example embodiments of the present disclosure. In some embodiments, during the operation of process 200, the first microservice 116a can operate as the SOR of the system 100 and the second microservice 116b can operate as the SoREF of the system 100. At block 201, the process 200 can include receiving a request to modify a data table 112 stored in the database 110 within the monolithic application 106 from a user device 102. The request can be received by any of the microservices 116a-n or the monolithic application 106 (e.g., via any of its capabilities 108a-n). If the request to modify the data table 112 is received by the monolithic application 106 or a microservice other than microservice 116a (i.e., one of microservices 116b-n), the redirection module 118 can redirect the request to the first microservice 116a, the SOR. In some embodiments, the monolithic application 106 can include a faøade layer and redirecting the request to the first microservice 116a can include transforming the request to an API request to the first microservice and routing the API request to the first microservice 116a via the fçcade layer. Once the request to modify data is received by the first microservice 116a (either originally or via the redirection module 118), processing can proceed to block 202.

At block 202, the process 200 can include applying, via the first microservice 116a, the update to the data table 112 based on the request to modify data. For example, the request may be to add, modify, or delete data within the data table 112. As discussed above in relation to FIG. 1, because the first microservice 116a operates as the SOR of the system 100, it has the capability to access database 110 to update the data table 112 according to the received request. In some embodiments, applying the update can include updating a state of the update to “pending.” At block 203, the process 200 can include publishing, via the first microservice 116a, an event reflecting the updates made to the data table 112 to the outbox table 120. In some embodiments, publishing the event to the outbox table 120 can include writing the event payload to the outbox table 120. In some embodiments, a post commit operation can pick up the event payload from the outbox table 120 and publish it on an eventbus. In other words, the various capabilities 108a-n and the other microservices 116b-n can access the event via the eventbus.

At block 204, the process 200 can include consuming, via e.g., the second microservice 116b, the published event. In some embodiments, one or more of the first microservice 116a, the second microservice 116b, and/or the monolithic application 106 can run a scheduler (e.g., a spring scheduler) to retry messages if they fail to ensure updates are consistently obtained, which can ensure updates to the first microservice 116a are published to the eventbus for the consumption by the SoREFs (e.g., the second microservice 116b and the monolithic application 106). In some embodiments, the second microservice 116b can be configured to access the eventbus and save incoming messages in its own inbox DB table (not shown in FIG. 1), committing the offset, and processing the data change in the background (block 205). In addition, “failed” messages can be saved to the inbox table to ensure that the above-mentioned schedulers can perform retries before purging the message/event. In some embodiments, the second microservice 116b can move the relevant message into a dead letter queue if the event cannot be consumed after a plurality of configurable retries have been performed. In some embodiments, the dead letter queue can be a DynamoDB. The messages saved in the dead letter queue can be handled by various personnel to identify issues and fix data correspondingly.

At block 205, the process 200 can include applying, via the second microservice 116b, the update to a local copy of the data table 112. In other words, the second microservice 116b stores and maintains a copy of the data table 112 locally. In some embodiments, prior to applying the update, the first microservice 116a can perform a validation check before updating the data table 112 to ensure the correctness of the update payload. In some embodiments, applying the update to the local copy of the data table 112 can also include updating a state of the update in the local copy to “pending.”

At block 206, the process 200 can include making, via the second microservice 116b, a call to the monolithic application 106 to perform the update. In some embodiments, the call can be a synchronous call. At block 207, the process 200 can include, after receiving the call from the second microservice 116b, applying, via the monolithic application 106, the update to another local copy of the data, one owned and managed by the monolithic application 106. In some embodiments, the monolithic application 106 can apply updates without utilizing or maintaining any states. At block 208, the process 200 can include redirecting, via the monolithic application 106, a call to the first microservice 116a. At block 209, the process 200 can include, upon receiving the redirected call from the monolithic application 106, updating, via the first microservice 116a, the state of its update to “ready.” At block 210, the process 200 can include updating, via the second microservice 116b, the state of its update to “ready.” This manner of applying updates and managing such updates via a sequential updating of “states” of the update, ensuring consistent processing and accuracy across the system 100. This can also ensure that the SoR (the first microservice 116a) remains the source of truth of the system 100. Alternately, in some embodiments where a status may not properly update as “ready” (i.e., in either the first microservice 116a or the second microservice 116b), the system 100 can determine whether there is an optimistic locking error. If there is, the statuses can be updated to “ready” and the update propagation treated as successful. If the error is not an optimistic locking error, the updating of the statuses can be retried a predefined number of times; if the updates are still unsuccessful, a timeout error can be returned to the user.

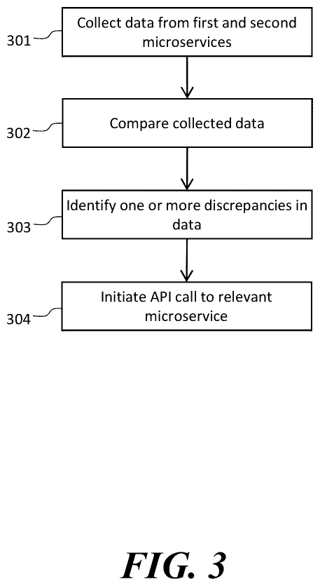

FIG. 3 is a flowchart of an example data validation process 300 according to example embodiments of the present disclosure. In some embodiments, the data validation process 300 can be performed by the validation module 122. At block 301, the validation module 122 can collect data from a first and second microservice, such as the first microservice 116a and the second microservice 116b. In some embodiments, this can include collecting data from the SOR and SoREF, although this is not required. At block 302, the validation module 122 can compare the data collected from each of the first microservice 116a and the second microservice 116b. In some embodiments, the validation module 122 can access the data table 112 maintained by the SOR (microservice 116a) and a local copy of the data table 112 maintained by the SoREF (microservice 116b) and perform a field level comparison for the properties within the table. At block 303, the validation module 122 can identify one or more discrepancies within the collected data. For example, an update made to the data table 112 by the first microservice 116a may not have been successfully propagated to the local copy of the data table 112 within the second microservice 116b. At block 304, the validation module 122 initiates an API call to the relevant microservice to remedy the data table.

The disclosed principles can offer various benefits and advantages. First, the disclosed principles can enhance data constituency and integrity across the monolithic application and various microservices. Second, the disclosed principles can improve system flexibility and scalability. Decomposing a monolithic system into microservices generally enhances flexibility because each microservice can be developed, deployed, scaled, and updated independently, which can lead to better resource utilization and system scalability. Third, the disclosed principles can reduce risk during migration. In particular, such a system allows for a gradual migration from a monolithic architecture to a microservices-based architecture. By decomposing capabilities step-by-step and ensuring synchronized data as disclosed herein, the risk associated with a full-scale migration is reduced. Fourth, the disclosed principles can increase system resilience. In a distributed system architecture, the failure of one component (e.g., a microservice) does not necessarily bring down the entire system. However, the system described herein uses compensating transactions, which further enhances system resilience by providing a clear path for recovery in the case of failures. Fifth, the disclosed principles can enable asynchronous processing for enhanced performance by reducing the need for synchronous waits and decreasing the likelihood of bottlenecks within the system. Sixth, the disclosed principles enable an easier method for integrating new microservices within existing monolithic systems, which can be particularly beneficial for an organization looking to modernize its infrastructure without discarding significant investments that have gone into the legacy system. Moreover, the disclosed principles can promote a clear separation of concerns by distributing data and capabilities across different microservices and the monolithic application. This can simplify maintenance, enhance clarity in system functionality, and make implementing changes and updates easier.

FIG. 4 is a diagram of an example server device 400 that can be used within system 100 of FIG. 1. Server device 400 can implement various features and processes as described herein. Server device 400 can be implemented on any electronic device that runs software applications derived from complied instructions, including without limitation personal computers, servers, smart phones, media players, electronic tablets, game consoles, email devices, etc. In some implementations, server device 400 can include one or more processors 402, volatile memory 404, non-volatile memory 406, and one or more peripherals 408. These components can be interconnected by one or more computer buses 410.

Processor(s) 402 can use any known processor technology, including but not limited to graphics processors and multi-core processors. Suitable processors for the execution of a program of instructions can include, by way of example, both general and special purpose microprocessors, and the sole processor or one of multiple processors or cores, of any kind of computer. Bus 410 can be any known internal or external bus technology, including but not limited to ISA, EISA, PCI, PCI Express, USB, Serial ATA, or FireWire. Volatile memory 404 can include, for example, SDRAM. Processor 402 can receive instructions and data from a read-only memory or a random access memory or both. Essential elements of a computer can include a processor for executing instructions and one or more memories for storing instructions and data.

Non-volatile memory 406 can include by way of example semiconductor memory devices, such as EPROM, EEPROM, and flash memory devices; magnetic disks such as internal hard disks and removable disks; magneto-optical disks; and CD-ROM and DVD-ROM disks. Non-volatile memory 406 can store various computer instructions including operating system instructions 412, communication instructions 414, application instructions 416, and application data 417. Operating system instructions 412 can include instructions for implementing an operating system (e.g., Mac OS®, Windows®, or Linux). The operating system can be multi-user, multiprocessing, multitasking, multithreading, real-time, and the like. Communication instructions 414 can include network communications instructions, for example, software for implementing communication protocols, such as TCP/IP, HTTP, Ethernet, telephony, etc. Application instructions 416 can include instructions for various applications. Application data 417 can include data corresponding to the applications.

Peripherals 408 can be included within server device 400 or operatively coupled to communicate with server device 400. Peripherals 408 can include, for example, network subsystem 418, input controller 420, and disk controller 422. Network subsystem 418 can include, for example, an Ethernet of WiFi adapter. Input controller 420 can be any known input device technology, including but not limited to a keyboard (including a virtual keyboard), mouse, track ball, and touch-sensitive pad or display. Disk controller 422 can include one or more mass storage devices for storing data files; such devices include magnetic disks, such as internal hard disks and removable disks; magneto-optical disks; and optical disks.

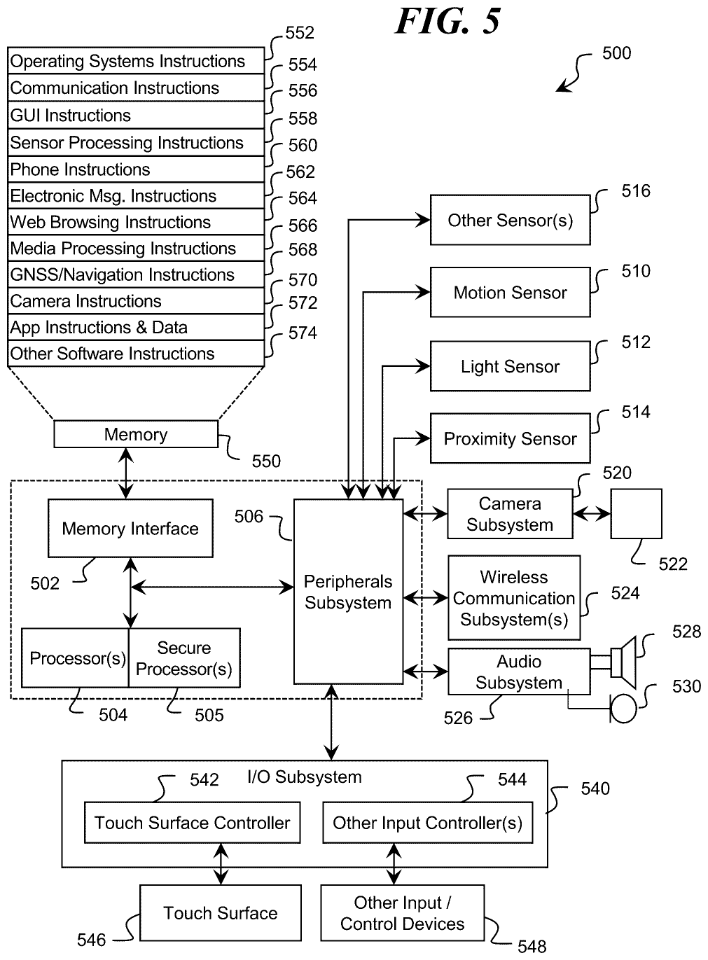

FIG. 5 is an example computing device that can be used within the system 100 of FIG. 1, according to an embodiment of the present disclosure. In some embodiments, device 500 can be user device 102. The illustrative user device 500 can include a memory interface 502, one or more data processors, image processors, central processing units 504, and or secure processing units 505, and peripherals subsystem 506. Memory interface 502, one or more central processing units 504 and or secure processing units 505, and or peripherals subsystem 506 can be separate components or can be integrated in one or more integrated circuits. The various components in user device 500 can be coupled by one or more communication buses or signal lines.

Sensors, devices, and subsystems can be coupled to peripherals subsystem 506 to facilitate multiple functionalities. For example, motion sensor 510, light sensor 512, and proximity sensor 514 can be coupled to peripherals subsystem 506 to facilitate orientation, lighting, and proximity functions. Other sensors 516 can also be connected to peripherals subsystem 506, such as a global navigation satellite system (GNSS) (e.g., GPS receiver), a temperature sensor, a biometric sensor, magnetometer, or other sensing device, to facilitate related functionalities.

Camera subsystem 520 and optical sensor 522, e.g., a charged coupled device (CCD) or a complementary metal-oxide semiconductor (CMOS) optical sensor, can be utilized to facilitate camera functions, such as recording photographs and video clips. Camera subsystem 520 and optical sensor 522 can be used to collect images of a user to be used during authentication of a user, e.g., by performing facial recognition analysis.

Communication functions can be facilitated through one or more wired and or wireless communication subsystems 524, which can include radio frequency receivers and transmitters and or optical (e.g., infrared) receivers and transmitters. For example, the Bluetooth (e.g., Bluetooth low energy (BTLE)) and or WiFi communications described herein can be handled by wireless communication subsystems 524. The specific design and implementation of communication subsystems 524 can depend on the communication network(s) over which the user device 500 is intended to operate. For example, user device 500 can include communication subsystems 524 designed to operate over a GSM network, a GPRS network, an EDGE network, a WiFi or WiMax network, and a Bluetooth™ network. For example, wireless communication subsystems 524 can include hosting protocols such that device 500 can be configured as a base station for other wireless devices and or to provide a WiFi service.

Audio subsystem 526 can be coupled to speaker 528 and microphone 530 to facilitate voice-enabled functions, such as speaker recognition, voice replication, digital recording, and telephony functions. Audio subsystem 526 can be configured to facilitate processing voice commands, voice-printing, and voice authentication, for example.

I/O subsystem 540 can include a touch-surface controller 542 and or other input controller(s) 544. Touch-surface controller 542 can be coupled to a touch-surface 546. Touch-surface 546 and touch-surface controller 542 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch-surface 546.

The other input controller(s) 544 can be coupled to other input/control devices 548, such as one or more buttons, rocker switches, thumb-wheel, infrared port, USB port, and or a pointer device such as a stylus. The one or more buttons (not shown) can include an up/down button for volume control of speaker 528 and or microphone 530.

In some implementations, a pressing of the button for a first duration can disengage a lock of touch-surface 546; and a pressing of the button for a second duration that is longer than the first duration can turn power to user device 500 on or off. Pressing the button for a third duration can activate a voice control, or voice command, module that enables the user to speak commands into microphone 530 to cause the device to execute the spoken command. The user can customize a functionality of one or more of the buttons. Touch-surface 546 can, for example, also be used to implement virtual or soft buttons and or a keyboard.

In some implementations, user device 500 can present recorded audio and or video files, such as MP3, AAC, and MPEG files. In some implementations, user device 500 can include the functionality of an MP3 player, such as an iPod™. User device 500 can, therefore, include a 36-pin connector and or 8-pin connector that is compatible with the iPod. Other input/output and control devices can also be used.

Memory interface 502 can be coupled to memory 550. Memory 550 can include high-speed random access memory and or non-volatile memory, such as one or more magnetic disk storage devices, one or more optical storage devices, and or flash memory (e.g., NAND, NOR). Memory 550 can store an operating system 552, such as Darwin, RTXC, LINUX, UNIX, OS X, Windows, or an embedded operating system such as VxWorks.

Operating system 552 can include instructions for handling basic system services and for performing hardware dependent tasks. In some implementations, operating system 552 can be a kernel (e.g., UNIX kernel). In some implementations, operating system 552 can include instructions for performing voice authentication.

Memory 550 can also store communication instructions 554 to facilitate communicating with one or more additional devices, one or more computers and or one or more servers. Memory 550 can include graphical user interface instructions 556 to facilitate graphic user interface processing; sensor processing instructions 558 to facilitate sensor-related processing and functions; phone instructions 560 to facilitate phone-related processes and functions; electronic messaging instructions 562 to facilitate electronic messaging-related process and functions; web browsing instructions 564 to facilitate web browsing-related processes and functions; media processing instructions 566 to facilitate media processing-related functions and processes; GNSS/Navigation instructions 568 to facilitate GNSS and navigation-related processes and instructions; and or camera instructions 570 to facilitate camera-related processes and functions.

Memory 550 can store application (or “app”) instructions and data 472, such as instructions for the apps described above in the context of FIGS. 1-3. Memory 550 can also store other software instructions 574 for various other software applications in place on device 500. The described features can be implemented in one or more computer programs that can be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

The described features can be implemented in one or more computer programs that can be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions can include, by way of example, both general and special purpose microprocessors, and the sole processor or one of multiple processors or cores, of any kind of computer. Generally, a processor can receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail may be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112 (f). Claims that do not expressly include the phrase “means for” or “step for” are not to be interpreted under 35 U.S.C. 112 (f).

1. A computing system comprising:
a processor; and
a non-transitory computer-readable storage device storing computer-executable instructions for operating a monolithic application, a first microservice, and a second microservice, the instructions operable to cause the processor to perform operations comprising:
receiving a request to modify a data table stored in a database within the monolithic application wherein receiving the request to modify the data table comprises:
receiving the request to modify the data table via the second microservice or the monolithic application; and
redirecting, via the monolithic application, the request to the first microservice;
applying, via the first microservice, an update to the data table based on the request;
publishing, via the first microservice, an event reflecting updates to the data table;
consuming, via the second microservice, the published event; and
applying, via the second microservice, the update to a local copy of the data table at the second microservice.

2. The computing system of claim 1, wherein the first microservice operates as a system of record within the system.

3. The computing system of claim 1, wherein the second microservice and the monolithic application operate as systems of reference within the system.

4. The computing system of claim 1, wherein receiving the request to modify the data table comprises receiving the request to modify the data table via the first microservice.

5. The computing system of claim 1, wherein the operations comprise:
making, via the second microservice, a synchronous call to the monolithic application;
applying, via the monolithic application, the update to a local copy of the data at the monolithic application;
redirecting, via the monolithic application, to the first microservice;
updating, via the first microservice, a state of the update at the first microservice to a ready state; and
updating, via the second microservice, a state of the update at the second microservice to a ready state.

6. The computing system of claim 1, wherein the monolithic application comprises a fçcade layer and redirecting the request to the first microservice comprises:
transforming, via the fçcade layer, the request to a request to the first microservice; and
routing, via the fçcade layer, the transformed request to the first microservice before an update is made in the database.

7. The computing system of claim 1, wherein the operations further comprise, purging the update if a user retry request is not received before detecting a timeout error.

8. The computing system of claim 1, wherein publishing the event comprises:
writing an event payload to an outbox table; and
publishing, via a post commit operation, on an event bus.

9. The computing system of claim 1, wherein each of the monolithic application, the first microservice, and the second microservice runs a scheduler configured to retry failed messages.

10. The computing system of claim 1, wherein the operations further comprise operations performed via a validation module comprising:
collecting data from the first and second microservices;
comparing the collected data;
identifying one or more discrepancies in the collected data between the first and second microservices; and
initiating an application programming interface (API) call to the associated microservice.

11. A computer-implemented method, performed by at least one processor, comprising:
receiving a request to modify a data table stored in a database within a monolithic application wherein receiving the request to modify the data table comprises:
receiving the request to modify the data table via a second microservice or the monolithic application; and
redirecting, via the monolithic application, the request to a first microservice;
applying, via the first microservice, an update to the data table based on the request;
publishing, via the first microservice, an event reflecting updates to the data table;
consuming, via the second microservice, the published event; and
applying, via the second microservice, the update to a local copy of the data table at the second microservice.

12. The computer-implemented method of claim 11, wherein the first microservice operates as a system of record within a system comprising the monolithic application, the first microservice, and the second microservice.

13. The computer-implemented method of claim 11, wherein the second microservice and the monolithic application operate as systems of reference within a system comprising the monolithic application, the first microservice, and the second microservice.

14. The computer-implemented method of claim 11, wherein receiving the request to modify the data table comprises receiving the request to modify the data table via the first microservice.

15. The computer-implemented method of claim 11 comprising:
making, via the second microservice, a synchronous call to the monolithic application;
applying, via the monolithic application, the update to a local copy of the data at the monolithic application;
redirecting, via the monolithic application, to the first microservice;
updating, via the first microservice, a state of the update at the first microservice to a ready state; and
updating, via the second microservice, a state of the update at the second microservice to a ready state.

16. The computer-implemented method of claim 11, wherein the monolithic application comprises a fçcade layer and redirecting the request to the first microservice comprises:
transforming, via the fçcade layer, the request to a request to the first microservice; and
routing, via the fçcade layer, the transformed request to the first microservice before an update is mased in the database.

17. The computer-implemented method of claim 11 comprising purging the update if a user retry request is not received before detecting a timeout error.

18. The computer-implemented method of claim 11, wherein publishing the event comprises:
writing an event payload to an outbox table; and
publishing, via a post commit operation, on an event bus.

19. The computer-implemented method of claim 11, wherein each of the monolithic application, the first microservice, and the second microservice runs a scheduler configured to retry failed messages.

20. The computer-implemented method of claim 11 comprising, via a validation module:
collecting data from the first and second microservices;
comparing the collected data;
identifying one or more discrepancies in the collected data between the first and second microservices; and
initiating an application programming interface (API) call to the associated microservice.
